(19) United States
(12) Patent Application Publication
(10) Pub. No.: US 2004/0090555 A1
(43) Pub. Date: May 13, 2004

(54) System and method for enabling audio speed conversion

(76) Inventor: Magdy Megeid, Zurich (CH)

Correspondence Address: Joseph S Tripoli, Thomson Multimedia Licensing Inc, PO Box 5312, Princeton, NJ, 08543-5312, US

(21) Appl. No.: 10/344,228

(22) PCT Filed: Jul. 19, 2001
(86) PCT No.: PCT/IB01/01302

(51) Int. Cl. H04N 9/475

(52) U.S. Cl. 348/515

(57) ABSTRACT

An audio speed converter provides audio speed changes without loosing relevant information, and is suitable for use with video systems so as to provide better synchronization between output audio and video signals. According to an exemplary embodiment, a system for processing an audio signal includes a first processor for receiving the audio signal at a first rate of speed, and processing the received audio signal in dependence upon a plurality of control signals. Each of the control signals represents a level of a different reference parameter. The first processor provides output of the received audio signal at a second rate of speed in dependence upon the processing. A speed rate comparator compares the second rate of speed to a required rate of speed, and generates a comparison signal in dependence upon the comparison. A second processor generates the control signals in dependence upon the comparison signal.

### BACKGROUND

1. Field of the Invention

The present invention generally relates to audio speed conversion, and more particularly, to a system and method that enables audio speed conversion such as voice speed conversion.

2. Background Information

Speed conversion systems can be used to enable multiple speed operation (e.g., fast, slow, etc.) in video and/or audio reproduction systems, such as color television (CTV) systems, video tape recorders (VTRs), digital video/versatile disk (DVD) systems, compact disk (CD) players, hearing aids, telephone answering machines and the like. Conventional audio speed converters generally differentiate between a silence interval and a sound interval in an audio signal. Deleting the silence interval and compressing the sound interval results in an increased audio speed. Conversely, expanding the silence and sound intervals results in a decreased audio speed.

In some cases, an output audio signal must be synchronized with an output video signal which is produced at a constant rate of speed. In such cases, it is necessary to control the speed of the output audio signal, which is often difficult due to the unknown amount of redundancy in the input audio signal. Conventional audio speed converters address this problem by dividing the input audio signal into fixed-length frames, and compressing each frame to a given duration. For example, if the audio output speed is set to twice (i.e., 2×) the normal speed, the converter compresses each frame to one-half its original duration. Since each of the frames represents different audio content, some of the frames may not have enough silence and redundancy intervals for proper signal compression. In such cases, the converter deletes part of one or more frames to reach a desired audio speed. Consequently, the output audio speed is kept nearly constant and may be adjusted at the end of each frame. This type of conventional speed control is graphically illustrated by FIG. 1.

In FIG. 1, a graph 60 shows an exemplary relationship between video speed (i.e., shown as a dashed line) and audio speed (i.e., shown as a solid line) over time. As indicated in FIG. 1, synchronization between video speed and audio speed is achieved by deleting part of one or more audio frames. Accordingly, actual synchronization only occurs at the end of each frame, but not necessarily during the rest of the frame period. This conventional type of speed control often provides unsatisfactory results since portions of the output audio signal may not be understandable to a listener. Accordingly, these types of conventional audio speed converters should therefore only be used in a limited number of applications, such as for a fast forward operation in a video tape recorder (VTR).

In view of the foregoing problems in the conventional art, it is recognized that an improved audio speed converter is needed. In particular, it is desirable to provide an audio speed converter which accommodates audio speed changes without loosing relevant information. Moreover, it is further desirable that such an audio speed converter be suitable for use with video systems so as to provide better synchronization between output audio and video signals. The present invention has been contemplated to address these and other problems.

### SUMMARY

In accordance with an aspect of the invention, a system for processing an audio signal comprises first processing means for receiving the audio signal at a first rate of speed, and processing the received audio signal in dependence upon a plurality of control signals. Each of the control signals represents a level of a different reference parameter. The first processing means provides output of the received audio signal at a second rate of speed in dependence upon the processing. Comparator means compare the second rate of speed to a required rate of speed, and generate a comparison signal in dependence upon the comparison. Second processing means generates the control signals in dependence upon the comparison signal.

In accordance with another aspect of the invention, a method for processing an audio signal includes receiving the audio signal at a first rate of speed. The received audio signal is processed in dependence upon a plurality of control signals each representing a level of a different reference parameter. The received audio signal is output at a second rate of speed in dependence upon the processing. The second rate of speed is compared to a required rate of speed, and a comparison signal is generated in dependence upon the comparison. The control signals are generated in dependence upon the comparison signal.

### BRIEF DESCRIPTION OF THE DRAWINGS

In the drawings:

FIG. 1 is a graph illustrating an exemplary relationship between video speed and audio speed according to conventional speed control techniques;

FIG. 2 is an audio speed converter constructed according to principles of the present invention;

FIG. 3 is an exemplary system including an audio speed converter constructed according to principles of the present invention;

FIG. 4 is a graph illustrating reference parameter levels of an exemplary input audio signal;

FIG. 5 is a graph illustrating an exemplary relationship between output audio quality and the level of a reference parameter P_{REF}; and

FIG. 6 is a graph illustrating an exemplary comparison between open looped and closed looped systems.

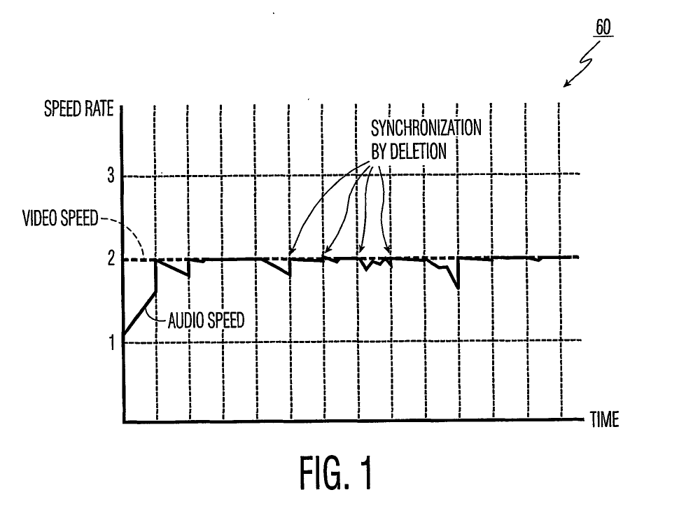

The exemplifications set out herein illustrate preferred embodiments of the invention, and such exemplifications are not to be construed as limiting the scope of the invention in any manner.

### DESCRIPTION OF THE PREFERRED EMBODIMENTS

This application discloses a system and method for processing an audio signal which provides audio speed changes without loosing relevant information, and is suitable for use with video systems so as to provide better synchronization between output audio and video signals. According to an exemplary embodiment, the system includes first processing means for receiving the audio signal at a first rate of speed, and processing the received audio signal in dependence upon a plurality of control signals. Each of the control signals represents a level of a different reference parameter. The first processing means provides output of the received audio signal at a second rate of speed in dependence upon the processing. According to an exemplary embodiment, the first processing means processes the received audio signal by one of compressing and expanding the received audio signal. Comparator means compare the second rate of speed to a required rate of speed, and generate a comparison signal in dependence upon the comparison. Second processing means generates the control signals in dependence upon the comparison signal. According to an exemplary embodiment, one of the reference parameters represented by the control signals is average power. The system may also include input means for enabling user input of the required rate of speed, and/or means for processing a video signal by synchronizing the video signal to said second rate of speed. A method performed by the foregoing system is also provided herein.

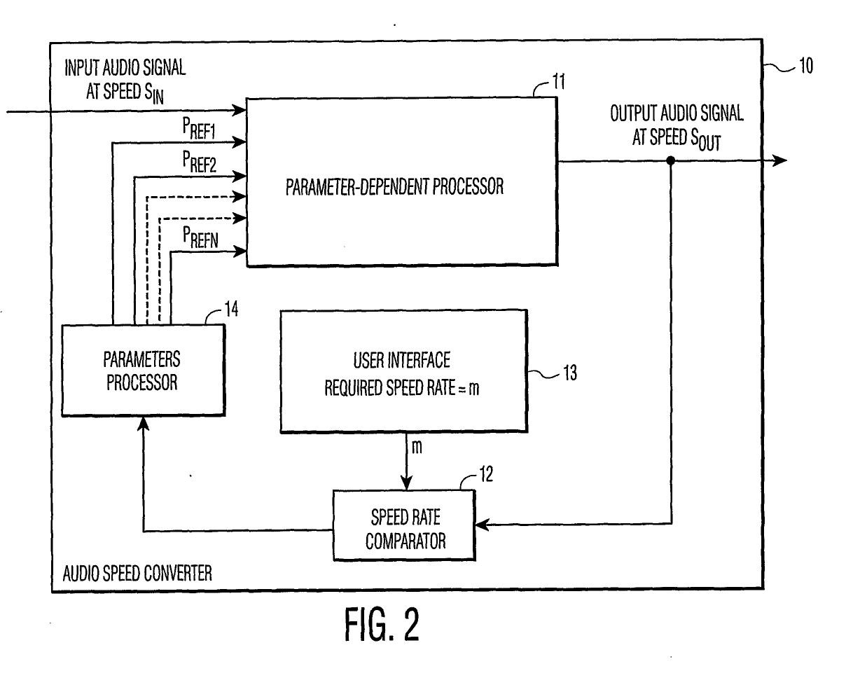

Referring now to the drawings, and more particularly to FIG. 2, an audio speed converter 10 constructed according to principles of the present invention is shown. In FIG. 2, the audio speed converter 10 includes first processing means such as a parameter-dependent processor 11. The parameter-dependent processor 11 receives an input audio signal such as a voice signal at a first rate of speed (S_{IN}). The parameter-dependent processor 11 processes the received audio signal by compressing or expanding the received audio signal in dependence upon a plurality of control signals to thereby generate an output audio signal at a second rate of speed (S_{OUT}). According to a preferred embodiment, each of the control signals represents a level of a different reference parameter (P_{REF1}, P_{REF2}, P_{REF3} . . . P_{REFN}).

Comparison means such as a speed rate comparator 12 receives from the parameter-dependent processor 11 the output audio signal and detects the speed thereof. Input means such as a user interface 13 enables various functions such as speed control by allowing a user to input a designated or required speed rate (m). The speed rate comparator 12 compares the detected speed (S_{OUT}) of the output audio signal to the required speed rate (m) and generates a comparison signal based on the result.

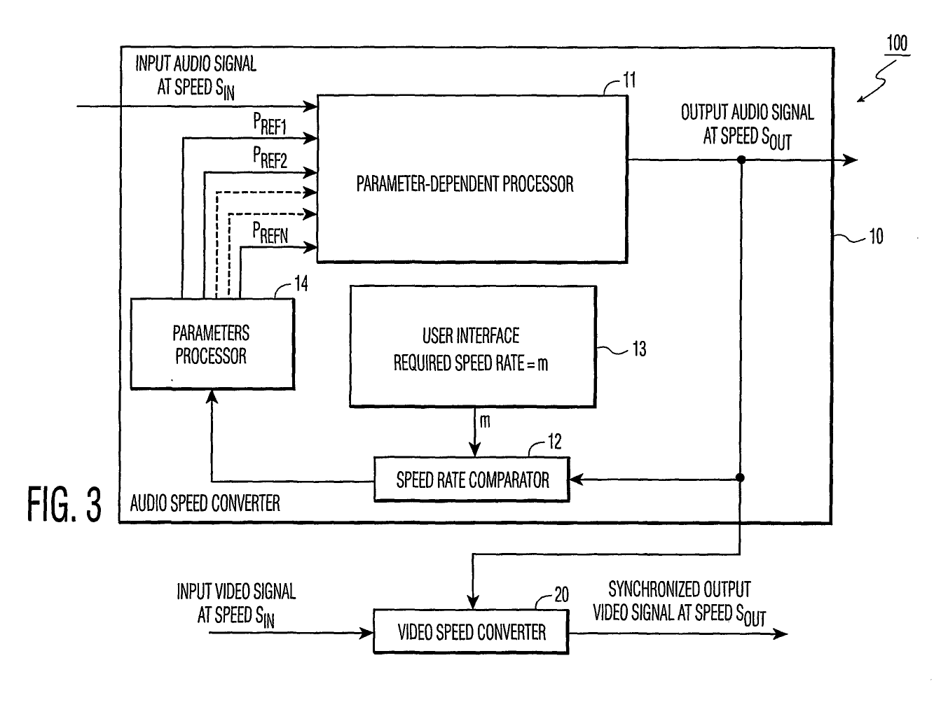

Second processing means such as a parameters processor 14 receives the comparison signal from the speed rate comparator 12. The parameters processor 14 generates the control signals in dependence upon the received comparison signal. Each of the control signals represents a level of a different reference parameter (P_{REF1}, P_{REF2}, P_{REF3} . . . P_{REFN}). The control signals are concurrently input to the parameter-dependent processor 11 to control signal compression and expansion operations of the parameter-dependent processor 11. As will be discussed further herein, the closed loop design of the audio speed converter 10 is useful for adaptively controlling audio speed based on the contents of the input audio signal. The audio speed converter 10 may also be incorporated in a system having both audio and video reproduction capabilities, as represented in FIG. 3.

Referring to FIG. 3, an exemplary system 100 including an audio speed converter 10 constructed according to principles of the present invention is shown. In FIG. 3, the system 100 is an audio/video system including an audio speed converter 10 as shown in FIG. 2, and a video speed converter 20. In the system 100 of FIG. 3, it is desirable for the output video signal to exhibit the same speed as the output audio signal. Therefore, for optimal video synchronization, the video speed converter 20 controls the speed of the output video signal using information regarding the momentary speed of the output audio signal. According to an embodiment, this information is provided to the video speed converter 20 as digital data via the output of the parameter-dependent processor 11, as indicated in FIG. 3. In this manner, the audio speed converter 10 operates as a “master” and the video speed converter 20 operates as a “slave.”

Further details regarding operation of the audio speed converter 10 constructed according to principles of the present invention will now be provided with reference to FIGS. 2 through 6.

As previously indicated, in FIGS. 2 and 3 the parameter-dependent processor 11 of the audio speed converter 10 receives an input audio signal at a first rate of speed (S_{IN}). The parameter-dependent processor 11 processes the received audio signal by compressing or expanding the received audio signal in dependence upon a plurality of control signals. Each of the control signals represents a level of a different reference parameter (P_{REF1}, P_{REF2}, P_{REF3} . . . P_{REFN}). The processing performed by the parameter-dependent processor 11 generates an output audio signal at a second rate of speed (S_{OUT}). In particular, compressing the received audio signal functions to increase the speed of the output audio signal. Conversely, expanding the received audio signal functions to decrease the speed of the output audio signal.

The speed rate comparator 12 receives the output audio signal and detects the speed thereof. That is, the speed rate comparator 12 detects the second rate of speed (S_{OUT}). The speed rate comparator 12 also receives an input signal representative of a required speed rate (m) from the user interface 13. The user interface 13 may be embodied as any type of input means such as a keypad, remote control or the like which allows a user to input a designated or required speed rate (m). The speed rate comparator 12 compares the detected speed (S_{OUT}) of the output audio signal to the required speed rate (m) and generates a comparison signal based on the result. According to an exemplary embodiment, the speed rate comparator 12 generates the comparison signal as a binary low signal to indicate that the required speed rate (m) has not yet been reached. Conversely, the speed rate comparator 12 generates the comparison signal as a binary high signal to indicate that the required speed rate (m) has been exceeded.

The parameters processor 14 receives the comparison signal from the speed rate comparator 12, and generates the control signals in dependence upon the received comparison signal. Each of the control signals represents a level of a different reference parameter (P_{REF1}, P_{REF2}, P_{REF3} . . . P_{REFN}). The control signals are Is concurrently input to the parameter-dependent processor 11, and are used to control the signal compression and expansion operations of the parameter-dependent processor 11. According to an exemplary embodiment, each of the reference parameters (P_{REF1}, P_{REF2}, P_{REF3} . . . P_{REFN}) represents a different, independent parameter of an audio signal. For example, the first reference parameter P_{REF1} may represent the average power of a received audio signal. The second reference parameter P_{REF2} may for example represent the similarity between two consecutive pitch periods of a received audio signal. The third reference parameter P_{REF3} may for example represent the difference between the number of cycles contained in two consecutive pitch periods of a received audio signal. Other parameters may of course be used in accordance with principles of the present invention.

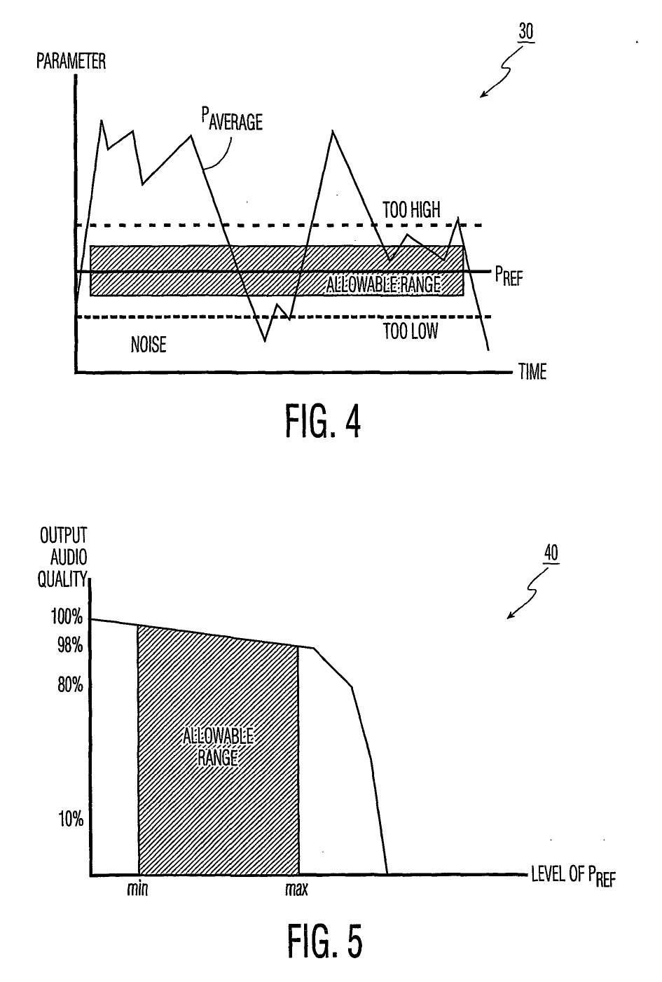

Average power is a particularly useful parameter for distinguishing between useful input audio signals and noise signals. The threshold for distinguishing between useful input audio signals and noise signals may generally be defined by the level of a reference parameter P_{REF}. Further details regarding an exemplary reference parameter P_{REF} will now be provided with reference to FIG. 4.

Referring to FIG. 4, a graph 30 illustrating parameter levels of an exemplary input audio signal is shown. For purposes of example, the parameter levels shown in FIG. 4 may correspond to average power levels of an exemplary input audio signal. In FIG. 4, an average parameter level P_{AVERAGE} oscillates above and below the level of a reference parameter P_{REF} over time. The average parameter level P_{AVERAGE} and the level of the reference parameter P_{REF} may be represented by digital values. If the average parameter level P_{AVERAGE} is greater than the level of the reference parameter P_{REF}, then the corresponding signal is deemed to be a useful audio signal. Otherwise, the signal is deemed to be a noise signal, and may accordingly be deleted.

As indicated in FIG. 4, if the level of a particular reference parameter P_{REF} is set too high (i.e., dotted line), this causes an increased portion of an input audio signal to be deemed a noise signal, and ultimately deleted. Alternatively, if the level of the reference parameter P_{REF} is set too low (i.e., dashed line), effective noise detection becomes more difficult. In practice, the level of a given reference parameter P_{REF} is arbitrary, but should be carefully selected according to design choice since it ultimately affects the quality of the output audio signal. It is recognized that suitable levels of a given reference parameter P_{REF} may exist within a small allowable range without degrading the quality of the output audio signal. An example of this allowable range for a given reference parameter P_{REF} is represented by the darkened area in FIG. 4.

Referring to FIG. 5, a graph 40 illustrating an exemplary relationship between output audio quality (i.e., understandability to a listener) and the level of a reference parameter P_{REF} is shown. As indicated in FIG. 5, exceeding the allowable range for a reference parameter P_{REF} may cause the quality of the output audio signal to dramatically deteriorate since useful audio signals are lost. It is important to note that the level of each reference parameter P_{REF} also affects compression rate, and ultimately audio output speed. For example, during a given time interval, an audio speed converter using a high threshold reference parameter P_{REF} deletes more noise than an audio speed converter using a lower threshold reference parameter P_{REF}. As previously indicated, the present invention uses a plurality of different, independent reference parameters (P_{REF1}, P_{REF2}, P_{REF3} . . . P_{REFN}) for detecting audio (i.e., sound) redundancies.

Referring back to FIGS. 2 and 3, the parameters processor 14 generates the control signals in response to the comparison signal generated by the speed rate converter 12, wherein each of the control signals represents a level of one of a plurality of different reference parameters (P_{REF1}, P_{REF2}, P_{REF3} . . . P_{REFN}). According to an exemplary embodiment, the parameters processor 14 utilizes “N” different reference parameters (P_{REF1}, P_{REF2}, P_{REF3} . . . P_{REFN}), each being represented by a separate digital value. The number of reference parameters “N” is selectable as a matter of design choice. In practice, the resolution for each of the different reference parameters (P_{REF1}, P_{REF2}, P_{REF3} . . . P_{REFN}) is not necessarily the same. For example, the level of a first reference parameter P_{REF1} may be represented by an 8-bit digital value, while the level of a second reference parameter P_{REF2} may be represented by a 14-bit digital value.

The parameters processor 14 generates the control signals so as to vary the level of each of the individual reference parameters (P_{REF1}, P_{REF2}, P_{REF3} . . . P_{REFN}) in accordance with the comparison signal generated by the speed rate comparator 12. That is, the parameters processor 14 varies the level of each of the reference parameters (P_{REF1}, P_{REF2}, P_{REF3} . . . P_{REFN}) in accordance with the comparison signal to reach the required speed rate (m). For example, in order to reach a required speed rate (m), the parameters processor 14 may generate the control signals so that the first reference parameter P_{REF1} becomes (P_{REF1}+/−ΔP_{REF1}), the second reference parameter P_{REF2} becomes (P_{REF2}+/−ΔP_{REF2}), the third reference parameter P_{REF3} becomes (P_{REF3}+/−ΔP_{REF3}) and the Nth reference parameter P_{REFN} becomes (P_{REFN}+/−ΔP_{REFN}). In the foregoing expressions, the “+/−” is necessary since an increase in audio speed does not necessarily require an increase in a reference parameter level, and vice-versa. Note also that although FIGS. 2 and 3 show the parameters processor 14 as having a separate output line for each of the reference parameters (P_{REF1}, P_{REF2}, P_{REF3} . . . P_{REFN}), it is possible in practice to reduce the number of such output lines by serially transmitting the control signals.

As an example, assume in FIGS. 2 and 3 that the audio speed converter 10 is operating normally without any speed adjustments (i.e., m=1). In this state, if a user inputs via the user interface 13 a required speed rate (m) equal to 2 (i.e., twice normal speed), the audio speed converter 10 operates to increase the speed (S_{OUT}) of the output audio signal to the required speed rate (m).

To effectuate the desired speed change, the speed rate comparator 12 receives the user input via the user interface 13 and initially detects that the speed (S_{OUT}) of the output audio signal has not yet reached the required speed rate (m) equal to 2. Accordingly, the speed rate comparator 12 generates the comparison signal as a binary low signal to indicate that the required speed rate (m) has not yet been reached. The parameters processor 14 receives the comparison signal in a binary low state, and responds by generating the control signals to indicate that the required speed rate (m) has not yet been reached. That is, the parameters processor 14 generates the control signals to vary the levels of the reference parameters (P_{REF1}, P_{REF2}, P_{REF3} . . . P_{REFN}) consistent with the required speed rate (m). The control signals in turn cause the parameter-dependent processor 11 to increase the speed (S_{OUT}) of the output audio signal by increasing the signal compression rate.

The speed rate comparator 12 detects the increased speed (S_{OUT}) of the output audio signal, and continues to generate the comparison signal as a binary low signal so long as the detected speed (S_{OUT}) of the output audio signal is less than the required speed rate (m). In a like manner, the parameters processor 14 continues to generate the control signals to vary the levels of the reference parameters (P_{REF1}, P_{REF2}, P_{REF3} . . . P_{REFN}) consistent with the required speed rate (m). This in turn causes the parameter-dependent processor 11 to further increase the speed (S_{OUT}) of the output audio signal by increasing the signal compression rate. This process continues until the speed rate comparator 12 detects that the required speed rate (m) has been exceeded, and generates the comparison signal in a binary high state.

Once the required speed rate (m) is exceeded, the parameters processor 14 generates the control signals to again vary the levels of the reference parameters (P_{REF1}, P_{REF2}, P_{REF3} . . . P_{REFN}) consistent with the required speed rate (m). This in turn causes the parameter-dependent processor 11 to decrease the speed (S_{OUT}) of the output audio signal by decreasing the signal compression rate. This loop-based process of iteratively varying the levels of the reference parameters (P_{REF1}, P_{REF2}, P_{REF3} . . . P_{REFN}) continues so as to lock the speed (S_{OUT}) of the output audio signal to the required speed rate (m). The audio speed converter 10 operates in a similar but inverse manner if the required speed rate (m) is less than 1.

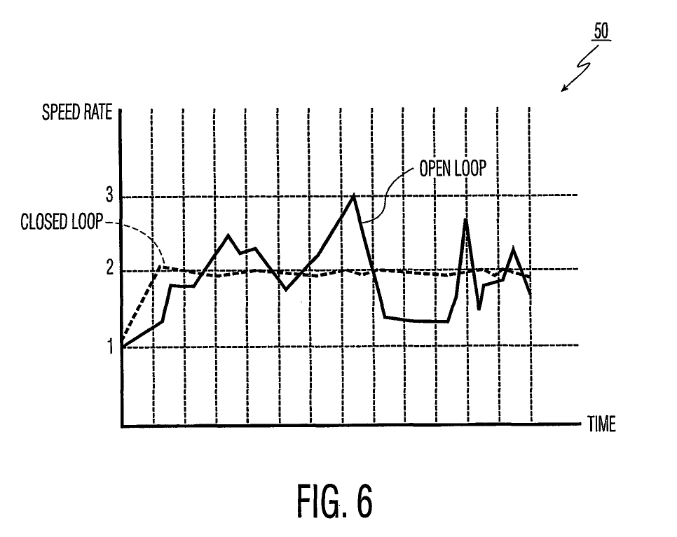

In the aforementioned manner, the parameter-dependent processor 11, the speed rate comparator 12 and the parameters processor 14 operate as a closed loop system to adaptively control audio speed based on the contents of the input audio signal. Moreover, this speed control technique may be incorporated in a system having both audio and video reproduction capabilities, as represented in FIG. 3. The benefits of a closed loop speed control system constructed according to principles of the present invention may be observed in FIG. 6.

Referring to FIG. 6, a graph 50 illustrating an exemplary comparison between open looped and closed looped systems is shown. As indicated in FIG. 6, an open loop system (i.e. solid line) produces an output audio signal at a speed that varies with time. This type of speed variation tends to irritate a listener. Conversely, a closed loop system (i.e., dashed line) such as one constructed according to principles of the present invention advantageously produces an output audio signal at a relatively constant rate of speed. A system constructed according to principles of the present invention provides enhanced functionality for audio and video products. For example, the present invention enables a user to save time by increasing audio and video speed in order to watch a movie at only 70% of its original duration, while ensuring good synchronization between audio and video segments. Moreover, a user may save time by replaying telephone answering machine messages at only 60% of their original duration. Additionally, compressing audio signals prior to recording reduces product cost as efficient storage becomes more feasible.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims.

1. A system for processing an audio signal, comprising:
first processing means (11) for receiving said audio signal at a first rate of speed (S_{IN}), processing said received audio signal in dependence upon a plurality of control signals each representing a level of a different reference parameter (P_{REF1}, P_{REF2}, P_{REF3} . . . P_{REFN}), and providing output of said received audio signal at a second rate of speed (S_{OUT}) in dependence upon said processing;
comparator means (12) for comparing said second rate of speed (S_{OUT}) to a required rate of speed (m), and generating a comparison signal in dependence upon said comparison; and
second processing means (14) for generating said control signals in dependence upon said comparison signal.

2. The system of claim 1, wherein one said reference parameter (P_{REF1}, P_{REF2}, P_{REF3} . . . P_{REFN}) represented by said control signals is average power.

3. The system of claim 1, further comprising input means (13) for enabling user input of said required rate of speed (m).

4. The system of claim 1, further comprising means (20) for processing a video signal by synchronizing said video signal to said second rate of speed (S_{OUT}).

5. The system of claim 1, wherein said first processing means (11) processes said received audio signal by one of compressing and expanding said received audio signal.

6. A system for processing an audio signal, comprising:
a first processor (11) for receiving said audio signal at a first rate of speed (S_{IN}), processing said received audio signal in dependence upon a plurality of control signals each representing a level of a different reference parameter (P_{REF1}, P_{REF2}, P_{REF3} . . . P_{REFN}), and providing output of said received audio signal at a second rate of speed (S_{OUT}) in dependence upon said processing;
a speed rate comparator (12) for comparing said second rate of speed (S_{OUT}) to a required rate of speed (m), and generating a comparison signal in dependence upon said comparison; and
a second processor (14) for generating said control signal in dependence upon said comparison signal.

7. The system of claim 6, wherein one said reference parameter (P_{REF1}, P_{REF2}, P_{REF3} . . . P_{REFN}) represented by said control signals is average power.

8. The system of claim 6, further comprising a user interface (13) for enabling user input of said required rate of speed (m).

9. The system of claim 6, further comprising a video signal processor (20) for processing a video signal by synchronizing said video signal to said second rate of speed (S_{OUT}).

10. The system of claim 6, wherein said first processor (11) processes said received audio signal by one of compressing and expanding said received audio signal.

11. A method for processing an audio signal, comprising steps of:
receiving said audio signal at a first rate of speed (S_{IN});
processing said received audio signal in dependence upon a plurality of control signals each representing a level of a different reference parameter (P_{REF1}, P_{REF2}, P_{REF3} . . . P_{REFN});
providing output of said received audio signal at a second rate of speed (S_{OUT}) in dependence upon said processing;
comparing said second rate of speed (Sour) to a required rate of speed (m); generating a comparison signal in dependence upon said comparison; and
generating said control signal in dependence upon said comparison signal.

12. The method of claim 11, wherein one said reference parameter (P_{REF1}, P_{REF2}, P_{REF3} . . . P_{REFN}) represented by said control signals is average power.

13. The method of claim 11, further comprising a step of enabling user input of said required rate of speed (m).

14. The method of claim 11, further comprising a step of processing a video signal by synchronizing said video signal to said second rate of speed (Sour).

15. The method of claim 11, wherein said step of processing of said received audio signal is performed by one of compressing and expanding said received audio signal.
